(19) United States
(12) Patent Application Publication
(10) Pub. No.: US 2025/0384512 A1
(43) Pub. Date: Dec. 18, 2025

(54) VEHICLE DRIVER ADVISORY APPLICATION

(71) Applicant: Stopsafe LLC, Cincinnati, OH (US)

(72) Inventor: Megan Crosby, Cincinnati, OH (US)

(21) Appl. No.: 19/037,962

(22) Filed: Jan. 27, 2025

Related U.S. Application Data
(60) Provisional application No. 63/625,309, filed on Jan. 26, 2024.

(51) Int. Cl. G06Q 50/26; G06F 40/20; H04M 1/72424

(52) U.S. Cl. CPC G06Q 50/265; G06F 40/20; H04M 1/72424

(57) ABSTRACT

The present disclosure recites a method and a system for providing a user involved in a traffic stop or accident with immediate access to information about their rights and step-by-step instructions on appropriate actions. A Stopsafe (SS) utility module may enable the user to access traffic stop and accident-related features via a mobile application. The SS utility module may provide interactive prompts that enable the user to receive situation specific advice from a virtual assistant through natural language processing and understanding. It may also allow the user to record the incident, automatically notify emergency contacts of the incident, and complete state specific accident forms. The application aims to protect civil rights and enhance safety by delivering clear, concise guidance tailored to real-time events. The application features an intuitive interface, educational content on rights, and practical advice on managing car accident situations.

### CROSS REFERENCE TO RELATED APPLICATIONS

This application claims priority from provisional application No. 63/625,309, filed on Jan. 26, 2024, the disclosure of which is herein incorporated by reference in its entirety.

### BACKGROUND

Mobile technology has revolutionized the way individuals access information and communicate. Smartphones and mobile applications have become indispensable tools for navigating daily life, offering instant access to a wealth of resources and services. Despite these advancements, there remains a need for specialized mobile applications that provide real-time, practical guidance during high-stress situations such as traffic stops and car accidents.

Encounters with police during traffic stops and car accidents are high stress situations that create uncertainty at what to do. Individuals may be unsure of their legal rights and the appropriate actions to take, which can lead to negative outcomes. Current resources, such as online guides or general know your rights advice websites, are often inadequate due to their lack of immediacy and specificity to the situation at hand.

Existing mobile applications focus primarily on navigation, communication, and general information but fall short in delivering timely, relevant, and actionable advice in critical moments. Therefore, there is a need for a mobile application that not only educates users about their rights but also provides step-by-step instructions tailored to real-time events during traffic stops and traffic accidents.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 illustrates a block diagram representation of an example data processing system (DPS) wherein certain features of a system and method of the present disclosure can be implemented, according to one or more versions;

FIG. 2 presents a screenshot of a graphical user interface (GUI) by which a user is provided training on how to use the features of the system and method of the present disclosure;

FIG. 3 presents a screenshot of a GUI by which a user can access situationally specific guidance during a traffic stop or accident, according to one or more versions of the system and method of the present disclosure;

FIG. 4 presents a flow chart illustrating the process of downloading a mobile application according to one or more versions of the system and method of the present disclosure and accessing its resources;

FIG. 5 presents a flow chart illustrating the process of accessing situationally specific information about user rights during a traffic stop, according to one or more versions of the system and method of the present disclosure; and

FIG. 6 presents a flow chart illustrating a process of accessing situationally specific guidance during a traffic accident, according to one or more versions of the system and method of the present disclosure.

### DETAILED DESCRIPTION

Various non-limiting versions of the present disclosure will now be described to provide an overall understanding of the principles of the structure, function, and use of the systems and processes disclosed herein. The features illustrated or described in connection with one non-limiting version may be combined with the features of other non-limiting versions. Such modifications and variations are intended to be included within the scope of the present disclosure.

Reference throughout the specification to “various versions,” “some versions,” “one version,” “some example versions,” “one example version,” or “a version” means that a particular feature, structure, or characteristic described in connection with any version is included in at least one version. Thus, appearances of the phrases “in various versions,” “in some versions,” “in one version,” “some example versions,” “one example version,” or “in a version” in places throughout the specification are not necessarily all referring to the same version. Furthermore, the particular features, structures or characteristics may be combined in any suitable manner in one or more versions.

Versions described herein generally related to a system and method of the present disclosure in the form of a mobile application designed to provide an individual with real-time, situationally specific guidance during traffic stops and after traffic accidents. In one or more versions, such a mobile application may empower users with immediate access to accurate information about their rights, reducing the uncertainty and anxiety that often accompany interactions with police and the aftermath of accidents. In one or more versions, such a mobile application offers step-by-step instructions tailored to the specific situation, ensuring users can respond appropriately and effectively, minimizing the risk of escalation or missteps. In one or more versions, such a mobile application can serve as an educational tool, enhancing public awareness and understanding of legal procedures and rights, which can lead to more informed interactions with authorities and other parties involved in accidents.

Described herein is a system and method that may be used in integrated car electronics, smartphones, and other portable devices in cars in the form of a mobile application. The mobile application may provide real-time guidance to users during traffic stops and car accidents. The mobile application may effectively increase user access to information about their rights during a traffic stop and may provide step-by-step instructions during a traffic accident based on real-time events.

The illustrations discussed herein are not intended to restrict or in any way limit the scope of the appended claims to such detail. Additionally advantages and modifications will readily appear to those skilled in the art. The disclosure in its broader aspects is therefore not limited to the specific details, representative apparatus and method, and illustrative examples shown and described. Accordingly, departures may be made from such details without departing from the spirit or scope of the applicant's general inventive concept. None of the features or components discussed below should be taken as mandatory for any specific implementation of any of the apparatuses, devices, systems or methods unless specifically designated as mandatory. Any failure to specifically describe a combination or sub-combination of components should not be understood as an indication that any combination or sub-combination may not be possible. Also, for any methods described, it should be understood that unless otherwise specified or required by context, any explicit or implicit ordering of steps performed in the execution of a method does not imply that those steps must be performed in the order presented but instead may be performed in a different order or in parallel.

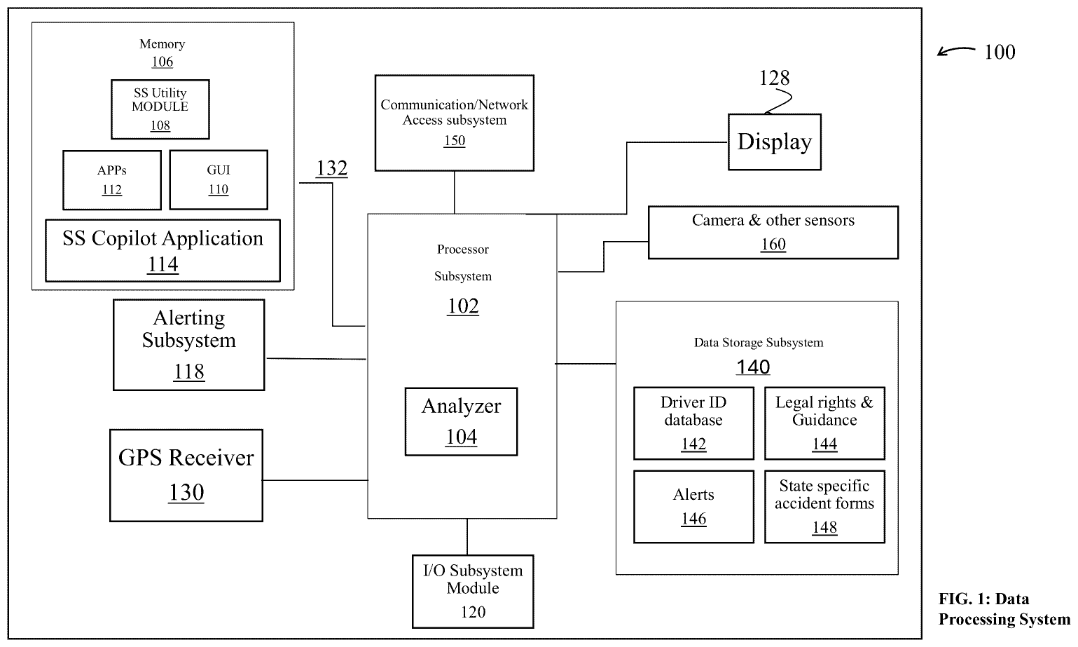

With reference now to the figures, and beginning with FIG. 1, there is depicted a block diagram representation of an example data processing system (DPS), as utilized within one embodiment. DPS may be a server, a digital audio workstation, a personal computer, a portable device, such as a personal digital assistant (PDA), a smartphone, and/or other types of electronic devices that may generally be considered processing devices or computing systems/devices. As illustrated, DPS 100 comprises at least one processor subsystem 102 connected to system memory 106 via system bus/interlink 132. DPS 100 executes one or more computer programs/applications to begin monitoring law enforcement encounters (e.g., traffic stops) and providing legal counsel to a user involved in a law enforcement encounter, according to the present disclosure.

In one or more embodiments, data processing device 100, which is managed by processor subsystem 102, also includes communication/network access subsystem 150, data storage subsystem 140, alerting subsystem 118, GPS receiver 130, cameras, and other sensors 170, and input/output (I/O) subsystem 120. As shown, processor subsystem 102 includes an analyzer module 104 to support the data analysis functionality of DPS 100. Processor subsystem 102 executes program code to provide operating functionality of data processing device 100. The software and/or firmware modules have varying functionality when their corresponding program code is executed by processor subsystem 102 or secondary processing devices (not explicitly shown) within DPS 100.

As illustrated, the DPS 100 includes an I/O subsystem 120. The I/O subsystem 120 includes user interface devices including output devices such as audio output device(s)/speaker, and a display device (not shown). In one or more implementations, the display device includes touch screen functionality enabling a display device to function as both an input device and an output device. In addition, I/O subsystem 120 includes input devices including a microphone, a keypad, and a mouse.

Processor subsystem 102 is communicatively coupled, via system bus/interlink 132, to device memory 106. In one or more embodiments, processor subsystem 102 is communicatively coupled via system bus/interlink 132 to communication/network access subsystem 150, data storage subsystem 140, and input/output subsystem 120. The bus/interlink 132 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components.

Communication/network access subsystem 150 may be configured to enable DPS 100 to communicate with a plurality of personal computing devices. The communication subsystem may include wired and/or wireless communication devices to facilitate networked communication. Communication/network access subsystem 150 also includes a Network Access Module by which DPS 100 may connect to one or more access/external networks such as the Internet or wide area network (WAN), or an internal network such as an Ethernet (local area network-LAN) or a Virtual Private Network (VPN).

In addition to the above described hardware components of DPS 100, various features of the invention are completed/supported via software (or firmware) code or logic stored within memory 106 or other storage and executed by processor subsystem 102. Thus, for example, illustrated within memory 106 are a number of software/firmware/logic components, including a traffic stop monitoring and legal counsel services (TSMLCS) application/module 114 and other applications (apps) 112. According to an aspect, the TSMLCS application 114 is an online/Internet-based mobile application. In addition, memory 106 comprises a traffic stop counsel (TSC) utility module 108. Device memory 106 further includes an operating system (OS) (not shown), a firmware interface, such as basic input/output system (BIOS) or Uniform Extensible Firmware Interface (UEFI), and firmware (not shown). Device memory 106 includes a graphical user interface (GUI) 110 and other computer data (not explicitly shown) used by the TSC utility module 108 and/or the traffic stop monitoring and legal counsel services application 114.

Data storage subsystem 140 enables further storage and retrieval of data, instructions, and code. In particular, data storage subsystem 140 provides applications, program code, and stored data on nonvolatile storage that is accessible by processor subsystem 102. For example, data storage subsystem 140 can provide, for use by the TSC utility module 108, the driver/user identification (ID) database 142, payment records 144, traffic laws and guidance database (DB) 146, traffic stop records 148, alerts 162, attorney identification (ID) 164, and traffic stop application and attorney services ratings 160. In addition, data storage subsystem 140 can provide a selection of program code and applications such as the traffic stop monitoring and traffic stop monitoring and legal counsel services application 114, and other related application(s) that can be used to monitor traffic stops and provide attorney services for traffic stop interactions between a police officer and a driver. These applications can be loaded into device memory 106 for execution by processor subsystem 102.

In actual implementation, the TSC utility module 108 may be combined with the traffic stop monitoring and legal counsel services application 114 to provide a single executable component, collectively providing the various functions of each individual component when the corresponding combined component is activated. For simplicity, the TSC utility module 108 is illustrated and described as a stand-alone or separate logic/firmware component, which provides specific functions, as described below.

In one embodiment, DPS 100 communicates with a software deploying server (not shown) via a network (e.g., the Internet) using communication subsystem/network access module 150. Then, TSC utility module 108 may be deployed from/on the network, via the software deploying server. With this configuration, the software deploying server performs all of the functions associated with the execution of TSC utility module 108. Accordingly, DPS 100 is not required to utilize internal computing resources of DPS 100 to execute TSC utility module 108.

The TSC utility module 108 provides an online platform for monitoring traffic stops and providing attorney legal services during traffic stop interactions between a police officer and a driver. The driver/user can be presented with audio, visual and/or textual content associated during the various stages of monitoring and reporting on traffic stop interactions by the online platform via an output device of the I/O subsystem. According to an aspect of the present disclosure, the TSC utility module 108 enables the individual to provide responses/feedback to the presented content via the GUI 110. According to one or more aspects, the individual/user can be presented with aural content via the speakers. The participant may also be visually presented via the display device with image, video and/or textual content. In addition, the participant may be visually presented with one or more associated selection buttons within the GUI 110. Using an input device, such as the mouse, the keypad or the microphone, the participant can provide an input selection as a response to presented content.

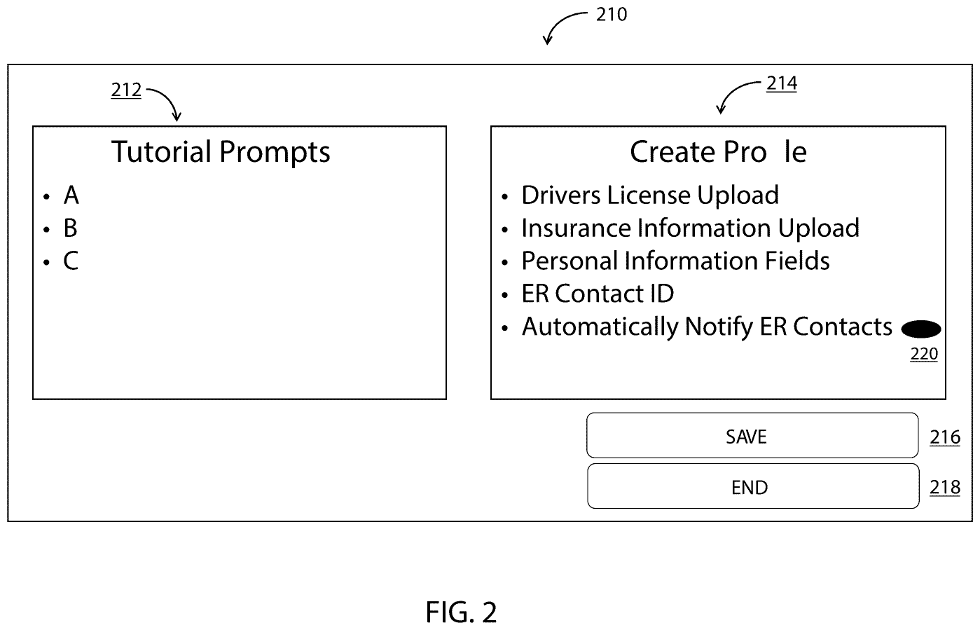

Certain of the functions supported and/or provided by the TSC utility module 108 are implemented as processing logic (or code) executed by processor subsystem 102 and/or other device hardware, which processing logic enables the device to implement/perform those function(s). Among the software code/instructions/logic provided by the TSC utility module 108, and which are specific to the disclosure, are: (a) logic for receiving from a user/driver an activation trigger to initiate execution of the traffic stop monitoring and legal counsel services (mobile) application: (b) logic for detecting selection of Traffic Stop features as a result of the user's interacting with a traffic stop Icon; (c) logic for providing an interactive “Call Attorney” button prompt that when selected verifies that the user wishes to initiate a call with an attorney to obtain legal advice; (d) logic for detect that a call is being initiated by the user based on a detected interaction with the Call Attorney button prompt; (e) logic for detecting that an active call connection between user and attorney has been established; (f) logic for enabling the attorney to witness the traffic stop event via a camera and a microphone of the user's device, and guide the user through an understanding of his legal rights; (g) logic for creating an audio-visual record of the traffic stop as a form of leg al documentation; (h) logic for initiating an App rating feature to enable the user to rate the mobile application and/or the attorney service; (i) logic for verifying a user's ID and location; (j) logic for initiating a search for available candidate attorneys in the current jurisdiction; and (k) logic for completing, via the mobile APP, a payment transaction for traffic attorney services using a linked user account. According to the illustrative embodiment, when Processor subsystem 102 executes the TSC utility module 108, DPS 100 initiates a series of functional processes that enable the above functional features as well as additional features/functionality. These features/functionalities are described in greater detail below within the description of FIGS. 2-5.

Those of ordinary skill in the art will appreciate that the hardware components and basic configuration depicted in FIG. 1 may vary. The illustrative components within DPS 100 are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure.

Referring now to FIG. 2, a graphical user interface (GUI) 110 by which a user is provided training on how to use the features in the application, according to one or more versions. As illustrated, GUI 110 includes a number of prompts including a tutorial prompts window 202 and a tutorial status window 210. GUI 110 is an example interface that may be provided by a cloud hosting service or other hosting server. When a user activates the application, the SS utility module 108 presents GUI 110 on display 128.

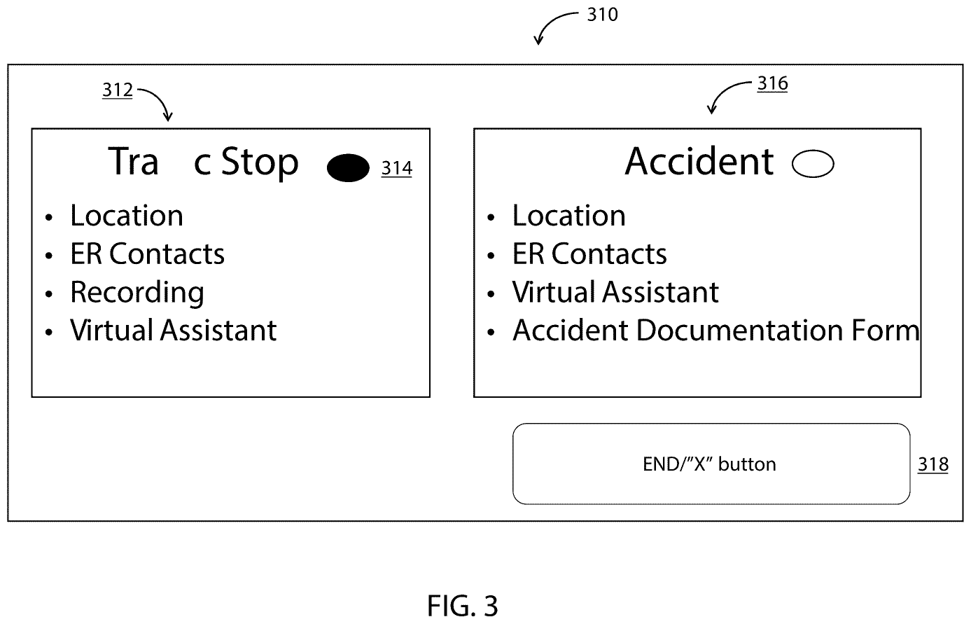

FIG. 3 illustrates an example screenshot of a GUI 310 by which a user can access situation specific guidance during a traffic stop or accident, according to one or more versions. As illustrated, GUI 310 includes a number of windows including a traffic stop window 302 and an accident window 304. Traffic stop window 302 presents a number of steps/aspects associated with protecting user legal rights and safety including: (i) location, (ii) contacting emergency contacts, (iii) recording the encounter, and (iv) and activating a virtual assistant that can respond to user inquiries. When the user selects the “traffic stop” option, SS utility module 108 may present in the Location window an interface in which the user can select to share their location or turn on automatic location sharing. After the location window closes, SS utility module 108 may present an additional window that has an option to share encounter information with emergency contacts. Encounter information may include location of the stop, time of the stop, and/or other relevant information. After such a window closes, the SS utility module 108 may present an additional window that has an option to record the encounter. After such a window closes, SS utility module 108 may present an additional window in which the user can ask a virtual assistant questions related to their rights and next steps to take during the encounter. The virtual assistant may provide the user answers based on a language model that is trained on legal data across the US. In one or more versions, virtual assistant may be trained on a language model such as autoregressive models, conditional generative models, enterprise LLMs, Retrieval Augmented Generation (RAG), and/or other LLMs.

When the user selects the “Accident” option 304, SS utility module 108 may present the same windows as described in the scenario where “Traffic Stop” 302 is selected. After a virtual assistant window, similar to the one described above, closes, SS utility module 108 may present an Accident Documentation Form in which the user may complete a general accident form and/or a state specific form to document the incident and export, save, or delete the completed form. Once completed, the user may export, save, and/or delete the form. In some embodiments, a user may opt to have forms exported automatically to an insurance app or website, a personal storage device, and/or otherwise exported.

SS utility module 108 may illustrate an active/current user selection by blacking out an interactive selection oval positioned adjacent to and to the right of the selected option. For example, the blacked out interactive selection oval 306 may indicate that the “Traffic Stop” option has been selected.

The selectable/presented options/items provided by GUI 310 have been described based on the specific example options/items illustrated in FIG. 3. However, this particular presentation of menu, function and options/items are provided for illustrative purposes, and the disclosure is by no means limited to the specific options/items and/or number of options/items presented.

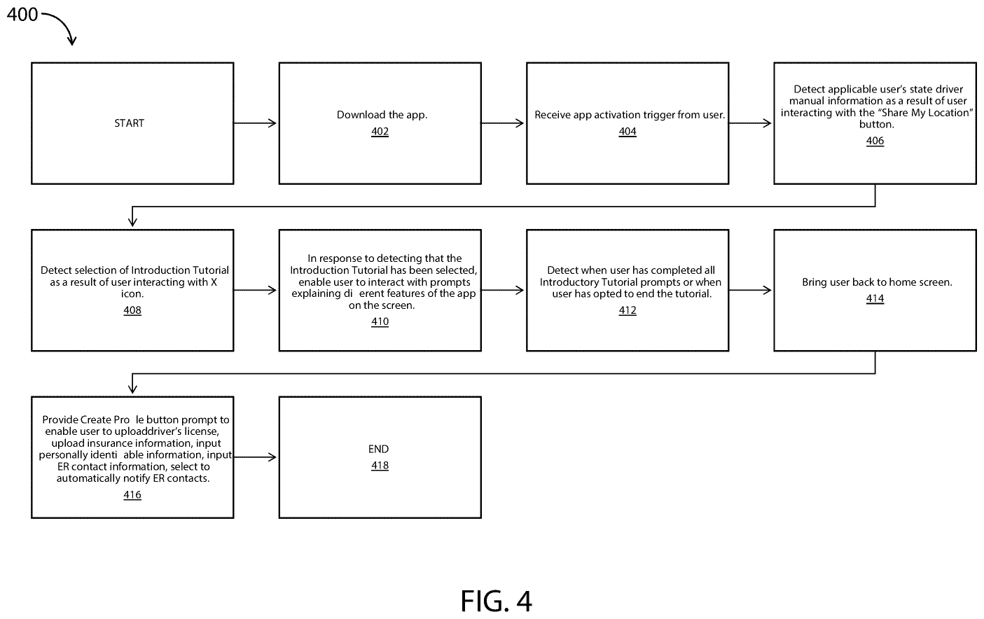

FIG. 4 presents a flow chart 400 illustrating the process of obtaining access to the mobile application discussed above. Process 400 may begin at the initiator/start block and proceed to block 402, at which the applicable mobile application store may receive an activation trigger from the user indicating that user wishes to start downloading the Stopsafe (SS) application 100. At block 404, SS utility module 108 may detect that the user is selecting to activate the application 100 as a result of the user interacting with the application's icon and/or voice recognition. According to an aspect, SS is a mobile application that provides a user, such as a driver, with knowledge of their rights when engaging in police encounters due to a traffic stop while also being able to provide a driver with instructions on steps to take if involved in a traffic accident. This will facilitate protection of civil rights and overall safety of the user during encounters with police officers and vehicle emergencies.

SS utility module 108 may provide to the user an interactive “Share My Location” button prompt that when selected may verify that the user wishes to share their location with the application to obtain an automatic download of the applicable state driver's manual, as shown at block 406. In some embodiments, the utility module 108 may search for relevant documents in the area in which the user/driver is located. These can include but are not limited to applicable insurance documents, AAA, ICE contacts and, first responder contact information. The utility module 108 may enable the user to choose from among the documents from which the user wishes to download to their user profile.

At block 408, SS utility module 108 may detect when the tutorial is being initiated by the user based on a detected user interaction with the “Start Introductory Tutorial” button prompt. In response to detecting that the Introductory Tutorial has been activated, SS utility module 108 may allow the user to engage with different prompts on the screen to explain the various application features, as shown at block 410.

SS utility module 108 may then detect when the user has finished all prompts or ends the tutorial, as shown at block 412. As described in FIG. 2 when the tutorial is over, or the user wants to end it, the user can end the tutorial and return to the home screen by pressing/interacting with the end button 210.

At block 414, SS utility module 108 may then take the user back to the home screen upon completion of the Introductory Tutorial. SS utility module 108 may prompt the user to create a profile, as shown at block 416. In some embodiments, when the user selects to create a profile, they are prompted to upload identification data and/or insurance data, the user is able to save this data by pressing/interacting with a SAVE button. The process may then proceed to the end block 418. In some embodiments, this information may be uploaded by scanning an identification card and/or insurance card with a user device.

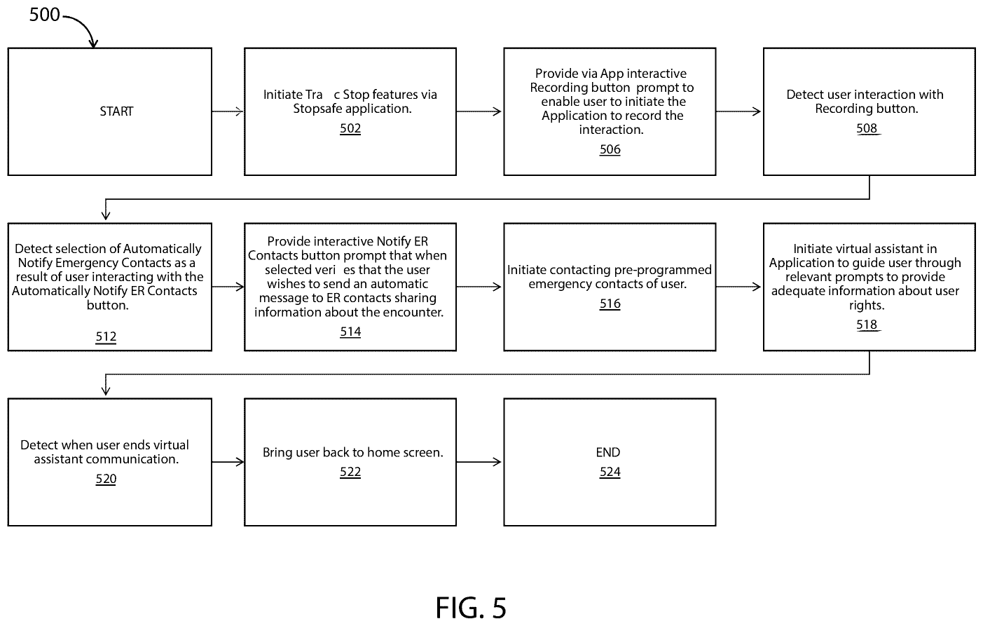

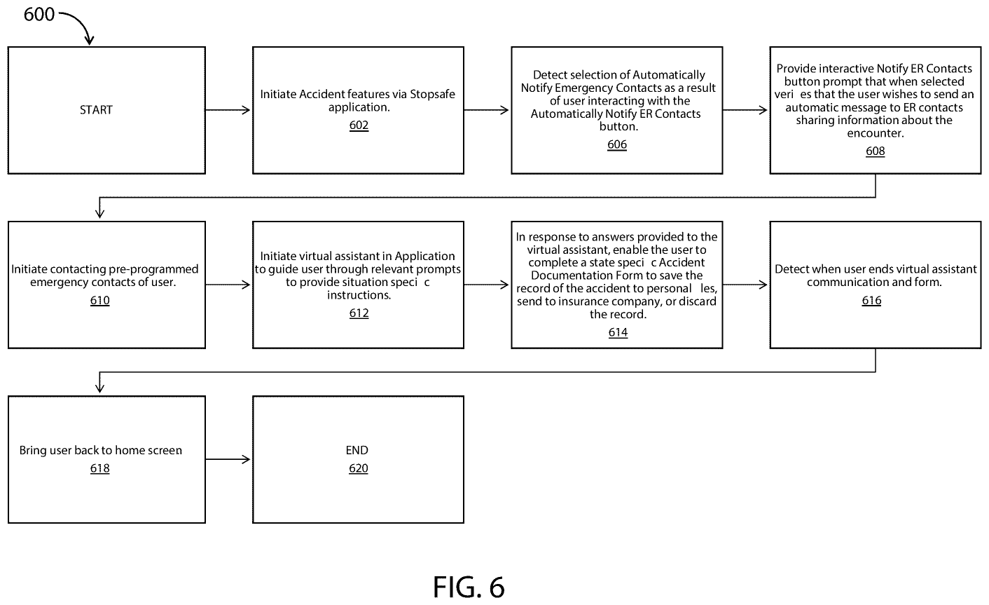

FIGS. 5 and 6 are flow charts illustrating various methods by which the above process of the illustrative versions is completed. Although the methods illustrated in FIGS. 5 and 6 may be described with reference to components shown in FIGS. 1-4, it should be understood that this is merely for convenience and alternative components and/or configurations thereof can be employed when implementing the various methods. Key portions of the methods may be completed by the SS utility module 108 executing on processor subsystem 102 within Data Processing Center (DPS) 100 (FIG. 1) and controlling specific operations of DPS 100, and the methods are thus described from the perspective of both SS utility module 108 and DPS 100 or other device that provide the functionality associated with one or more versions of SS utility module 108.

FIG. 5 presents a flowchart 500 illustrating a process of accessing situation specific information about user rights during a traffic stop, according to one or more versions. The process of FIG. 5 may begin at the initiator/start block and proceeds to block 502, at which SS utility module 108 receives an activation trigger from user indicating that the user wishes to start and utilize the traffic stop features of the SS application.

SS utility module 108 may provide to the user an interactive “Record” button prompt that when selected, verifies that the user wishes to initiate recording of the incident, as shown at block 506. At block 508, SS utility module 108 may detect when a recording is being initiated by the user based on a detected user interaction with the “Record” button prompt. SS utility module 108 may detect when a recording has started 508.

According to one or more aspects, SS utility module 108 enables the user to send an automatic message to pre-identified emergency contacts, via the messaging application of the user's device 512. At block 514, SS utility module 108 receives an activation trigger from user indicating that the user wishes to notify emergency contacts of the encounter, and as a result sends a notification message that may include the time and location of the traffic stop and/or other relevant information. In some embodiments, a user may opt-out of sending a message to one or more emergency contacts.

At block 516, SS utility module 108 detects that the user has completed the prompt of notifying emergency contacts and as a result will start the SS Copilot Application 114. According to an aspect, SS Copilot Application 114 is a mobile application virtual assistant that provides a user, such as a driver, with situation specific traffic stop and accident guidance to facilitate protection of civil rights and overall safety of the user during traffic stops or accidents.

SS utility module 108 may detect when the user is no longer interacting with SS Copilot Application 114, as shown at block 518. Alternatively, as described in FIG. 3, when the user is done using the SS Copilot Application 114, the user can end the chat features by pressing/interacting with the END/“X” button 318 (FIG. 3). In some embodiments, a user may verbally communicate a stop signal to the SS Copilot Application 114 to end the interaction. After an interaction is complete, the SS Copilot Application 114 may save the chat history, conduct a post-stop evaluation, and/or other actions. The post-stop evaluation may include asking the driver if they feel safe to resume their trip. If so, the driver may be prompted to update their emergency contacts who previously received a message with an update. If not, the driver may be prompted to take other precautions which may include calling an emergency contact, calling emergency services, or other appropriate precautions.

At block 520, SS utility module 108 may bring the user back to the home screen. The process may then proceed to the end block.

FIG. 6 presents a flowchart 600 illustrating a process of accessing situation specific guidance during an accident, according to one or more versions. The process of FIG. 6 may begin at the initiator/start block and proceed to block 602, at which SS utility module 108 receives an activation trigger from user indicating that the user wishes to start and utilize the accident features of the SS application.

According to one or more aspects, SS utility module 108 may enable the user to send an automatic message to pre-identified emergency contacts, via the messaging application of the user's device 606. At block 608, SS utility module 108 receives an activation trigger from user indicating that the user wishes to notify emergency contacts of the encounter, and as a result sends a notification message which may include the time and location of the traffic stop and/or other relevant information.

At block 610, SS utility module 108 may detect that the user has completed the prompt of notifying emergency contacts and as a result will start SS Copilot Application 114 for the user to receive situation specific instructions. According to an aspect, SS Copilot Application 114 will may provide the user with an accident documentation form, which may include one or more state specific forms based on the user's verified location, as shown at block 612. According to an implementation, SS utility module 108 may enable the user to choose whether to send the forms to their insurance agency, save the form, and/or delete the form. In some embodiments, the SS utility module 108 may integrate with a user's insurance app such that the SS utility module 108 can communicate traffic stop information to the insurance app. In some embodiments, the SS utility module 108 may generate an email that the user may send to their insurance company. The email may include the insurance policy number, user's name, accident form, a section for the user to insert the claim request, and/or other relevant information.

SS utility module 108 may detect when the user is no longer interacting with SS Copilot Application 114, as shown at block 614. Alternatively, as described in FIG. 3, when the user is done using SS Copilot Application 114, the user can end the chat features by pressing/interacting with the END/“X” button 310 (FIG. 3). In some embodiments, the user may end the interaction with the SS Copilot Application 114 by verbally indicating the end of the interaction.

At block 616, SS utility module 108 may bring the user back to the home screen. The process proceeds to the end block.

The foregoing description of versions and examples has been presented for purposes of illustration and description. It is not intended to be exhaustive or limiting to the forms described. Numerous modifications are possible in light of the above teachings. Some of those modifications have been discussed, and others will be understood by those skilled in the art. The versions were chosen and described in order to best illustrate principles of various versions as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

As described herein, a method and a system provide information about user rights and step-by-step instructions on appropriate actions to take when involved in a traffic stop or accident. A Stopsafe (SS) utility module may enable the user to access traffic stop and accident features via a mobile traffic stop application. According to an aspect, SS utility module may enable the user to perform ID and location verification. Following ID and location verification, the SS utility module may provide an interactive prompt that may enable the user to record the encounter and notify emergency contacts. Additionally, SS utility module may enable the user to receive situation specific information based on the information the user provides SS Copilot Application. According to an aspect, SS utility module may enable the user to save a record of the traffic stop as a form of legal documentation. In another aspect, SS utility module may enable the user to complete a general accident form which may include one or more state specific accident forms to send to their insurance agency, save to their personal files for future reference, and/or delete.

According to one or more aspects, the user devices include a personal/laptop/tablet computer and a smartphone. According to an aspect, the data processing (user) device is one or more of an Android platform and an IOS platform device.

According to one or more aspects, SS utility module 108 and SS Copilot Application 114 may be used to activate real time situation specific information for motorists that are involved in routine traffic stops or accidents.

According to an aspect, in response to a user's request, SS utility module 108 can provide a livestream which can be saved in the cloud to enable a safe and secure storage of the traffic stop record.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any version or claimed herein may be grouped or sub-grouped (and accordingly implicitly renamed) in any combination or sub-combination as those skilled in the art can imagine as suitable for the particular application, and still be within the scope and spirit of the claimed versions of the present invention.

Since many modifications, variations, and changes in detail can be made to the described preferred versions of the invention, it is intended that all matters in the foregoing description and shown in the accompanying drawings be interpreted as illustrative and not in a limiting sense. Thus, the scope of the invention should be determined by the appended claims and their legal equivalents.

We claim:

1. A non-transitory computer medium having executable code stored thereon, that when executed, cause a data processing system to perform operations comprising:
receiving an activation trigger from a first user device associated with a user during a traffic stop;
responsive to the activation trigger, verifying the user's identity and current location;
prompting the user to notify emergency contacts and record the interaction;
receiving an activation of the notify emergency contacts and record the interaction prompt initiating an automatic message to be sent to contacts and recording to begin after giving a recording signal; and
receiving, by the user through the first user device, situation specific advice about user rights during the law enforcement encounter.

2. The non-transitory computer medium of claim 1, wherein the operations performed by the data processing system further comprise:
initiating an automatic message sent to user's emergency contacts.

3. The non-transitory computer medium of claim 1, wherein the operations performed by the data processing system further comprise:
in real-time during the recording, providing real-time chat access, via typing or audio, to a virtual assistant through the SS Copilot Application during the law enforcement encounter.

4. The non-transitory computer medium of claim 3, wherein the operations performed by the data processing system further comprise:
receiving, by the user through the first user device, information about rights from the virtual assistant during the law enforcement encounter.

5. The non-transitory computer medium of claim 1, wherein the operations performed by the data processing system further comprise:
creating and storing an audio-visual record of the law enforcement encounter.

6. The non-transitory computer medium of claim 1, wherein the operations performed by the data processing system further comprise:
enabling user to export or delete the recording after the law enforcement encounter.

7. The non-transitory computer medium of claim 2, wherein the operations performed by the data processing system further comprise:
using natural language processing and natural language understanding to provide a response to user's inquiry.

8. The non-transitory computer medium of claim 2, wherein the operations performed by the data processing system further comprise:
initiating a search for relevant information about user rights in a current jurisdiction associated with the law enforcement encounter to provide situation specific advice.

9. A non-transitory computer medium having executable code stored thereon, that when executed, cause a data processing system to perform operations comprising:
receiving an activation trigger from a first user device associated with a user during an accident;
responsive to the activation trigger, verifying the user's identity and current location;
prompting the user to notify emergency contacts;
receiving an activation of the notify emergency contacts prompt and initiating an automatic message to be sent to contacts;
receiving, by the user through the first user device, step-by-step guidance on next steps during the accident; and
prompting the user to fill out one or more accident documentation forms.

10. The non-transitory computer medium of claim 9, wherein the operations performed by the data processing system further comprise:
initiating an automatic message sent to user's emergency contacts.

11. The non-transitory computer medium of claim 9, wherein the operations performed by the data processing system further comprise:
providing real-time chat access, via typing or audio, to a virtual assistant through the SS Copilot Application during the accident.

12. The non-transitory computer medium of claim 11, wherein the operations performed by the data processing system further comprise:
receiving, by the user through the first user device, step-by-step advice about next steps from the virtual assistant during the accident.

13. The non-transitory computer medium of claim 9, wherein the operations performed by the data processing system further comprise:
prompting the user to complete one or more accident specific forms in a current jurisdiction associated with the accident.
